(19) United States
(12) Patent Application Publication
(10) Pub. No.: US 2002/0016801 A1
(43) Pub. Date: Feb. 7, 2002

(54) Adaptive profile-based mobile document integration

(76) Inventors: Steven Reiley, San Jose, CA (US); Herman Fischer, Woodland Hills, CA (US); Yitao Yao, San Jose, CA (US); Sanjay Sinha, San Ramon, CA (US)

Correspondence Address: David A. Hall, Heller Ehrman White & McAuliffe LLP, 6th Floor, 4350 La Jolla Village Drive, San Diego, CA, 92122-1246, US

(21) Appl. No.: 09/886,299

(22) Filed: Jun. 21, 2001

Related U.S. Application Data
(60) Provisional application No. 60/222,069, filed on Aug. 1, 2000.
(60) Provisional application No. 60/232,373, filed on Sep. 14, 2000.

(51) Int. Cl. G06F 15/00

(52) U.S. Cl. 707/523

(57) ABSTRACT

A system transforms computer network content from a native format into a device specific format that is configured for use and display by a requesting device. The system includes a content transformer that is configured to process requests for content on a computer network, such as requests for Web pages over the Internet. The content transformer retrieves the content and conducts a semantic and/or heuristic analysis of the content using a set of general or user-defined rules. Based upon the analysis, the content transformer generates a user device version of the content that is tailored for display on the user device and that provides an easily-navigable overview of the content. Advantageously, the transformed version of the contents does not require the user device to have a high data transmission bandwidth or high memory capacity.

### REFERENCE TO RELATED APPLICATIONS

This application claims the benefit of priority from U.S. Provisional Application Ser. No. 60/222,069, entitled “Adaptive Profile-Based Mobile Document Integration,” filed Aug. 1, 2000, and U.S. Provisional Application Ser. No. 60/232,373, entitled “Adaptive Profile-Based Mobile Document Integration with Audio Transformation Capabilities,” filed Sep. 14, 2000, which are incorporated herein by reference.

### BACKGROUND OF THE INVENTION

1. Field of the Invention

The present invention relates to transformation of network data and, more particularly, to real-time transformation of World Wide Web documents into a format suitable for display on a client device.

2. Description of the Related Art

Users are increasingly accessing the Internet from a variety of devices other than traditional desktop or laptop computer systems. As the general population becomes more mobile and demand increases for access to the World Wide Web (the “Web”), users are turning to small footprint, mobile devices, such as mobile phones and personal digital assistants, for Web access. Such mobile devices are characterized by small display screens with lower screen resolution and reduced color depth over the display screens associated with desktop and laptop computers. Mobile devices typically also have smaller data transmission bandwidths and less memory capacity than desktop computers. The aforementioned devices are just the tip of the iceberg relating to the types of devices that will be used to access the Internet. It is only a matter of time before most televisions, VCRs, and even refrigerators will be able to access the Internet. Such devices will likely have display, memory and bandwidth characteristics that are similar to those of mobile devices.

Unfortunately, most existing Web pages are designed for browsers of desktop and laptop computers, which typically have large display screens, advanced image-rendering capabilities, such as a high screen resolution and color depth, and the ability to handle complex content, such as JavaScript. Additionally, many Web pages require the large bandwidth and large memory capacity that are generally available on desktop computers but unavailable on mobile devices. Consequently, most mobile devices do not have unfettered access to the Web. Rather, the mobile devices can only access Web content that is modified to support the small screen, monochrome color capabilities, and low bandwidth of the mobile device.

This eliminates a user's ability to access the same Web content using a mobile device. True surfing of the Web involves the user selecting and accessing Web sites according to the user's needs or even according to the user's whim. The user should also be able to follow the hyperlinks that make the Web so powerful. However, most users of mobile devices can only access those Web sites that have been specially-formatted for display on mobile devices.

Such specially-formatted Web pages are typically generated in one of two ways. One way is through “Web clipping,” which is a technique for reducing the amount of data downloaded to certain wireless, Web-enabled devices. According to this technique, a proxy (or wireless gateway) server fields queries from a wireless device relative to data available on the Internet. The proxy server then retrieves the data from the appropriate Web site, compresses the data into small clips, which represent only a portion of the entire data, and then sends the clips to the requesting device.

Unfortunately, this provides the user with a document that has a huge pile of text, often many screens worth, which can be too much for these tiny devices. Furthermore, the document is not organized according to any heuristics or semantics. The result is that the user is left trying to wade through the document to try and find anything of relevance. Moreover, Web clipping provides the user with only a clipped portion of the requested Web data, thereby reducing the users ability to access entire Web content and reducing the user's ability to freely surf the Web.

Another way of generating Web content for mobile devices is by assigning humans to manually re-write the Web content in a format that is suitable for the devices, such as in accordance with the Wireless Application Protocol (WAP). WAP depends on a Web page that has been rewritten for the small screen in Wireless Markup Language (WML).

Unfortunately, the WAP-enabled pages and Web clipped pages force Web site operators to have at least two versions of their Web sites, one for conventional PC access, and one for each other protocol that might be used by other devices, such as the mobile devices. Thus, extra processing resources and costs are involved, and there is necessarily some delay between the time a Web page is available to the general public and the time that page has been clipped and is available to service subscribers.

In light of the foregoing, there is a need for a way of enabling any Web-enabled device, including wireless mobile devices, to access existing content and applications from the wired Internet without requiring content providers to format the content for the specific device.

### SUMMARY OF THE INVENTION

The aforementioned needs are satisfied by the disclosed device and method for transforming content from a native format into a device specific format that is configured for use and display by a requesting device. The content transformer disclosed herein is configured to process requests for content on a computer network, such as requests for Web pages over the Internet. The content transformer retrieves the content and conducts a semantic and/or heuristic analysis of the content using a set of general or user-defined rules. Based upon the analysis, the content transformer generates a user device version of the content that is tailored for display on the user device and that provides an easily-navigable overview of the content. Advantageously, the transformed version of the contents does not require the user device to have a high data transmission bandwidth or high memory capacity.

The content transformer preferably divides the content into discrete data pieces, wherein the size of each data piece is tailored to fit within the bandwidth, screen display size, and memory capabilities of the user device. Each of the data pieces is then made available to the user device for downloading. Preferably, at least one of the data pieces includes data that provides a top level summary of the Web content. For example, where the content comprises a Web page with a volume of information, the content transformer generates an overview page that provides a top level overview of the information from the Web page and that is tailored to the markup, data transmission, display, and memory capabilities of the user device.

According to one aspect of the invention, a content transformer transforms a Web document from a first format into a second format. The content transformer retrieves a copy of the Web document, wherein the Web document comprises one or more elements that are delimited and identified by tags within the Web document; parses the Web document to create a first data structure comprised of a first hierarchical organization of elements from the Web document; conducts a semantic analysis of the elements in the data structure; and re-arranges the elements in the first data structure based upon the semantic analysis to form a second data structure comprised of a new hierarchical organization of elements from the Web page, wherein the new hierarchical organization differs from the first hierarchical organization.

In another aspect of the invention, a content transformer converts a Web page from a first format into a second format. The content transformer identifies page elements in the Web page; creates a native hierarchical arrangement having nodes that each correspond to a Web page element from the Web page; performs a structural and semantic analysis on the native hierarchical arrangement according to a set of rules, wherein the semantic analysis comprises examining the relative location and meaning of each element in the native hierarchical arrangement and identifying nodes for deletion from the hierarchical structure; and creates a transformed hierarchical arrangement based upon the structural and semantic analysis, wherein the transformed hierarchical arrangement takes into account the relative location and meaning of the elements in the native hierarchical arrangement.

In yet another aspect of the invention, a content transformer transforms a Web document. The content transformer retrieves a native format version of the Web document. The Web document includes one or more elements that are delimited by tags in the Web document, wherein the native format version of the Web document is not suitable for interpretation and display by a user device that requested the Web document. The content transformer further performs an analysis of the elements of the Web document, the analysis taking into account semantics of the elements and a structural arrangement of the elements; rearranges the elements as a result of the analysis to generate a hierarchical data structure that represents the Web document; and generates a user device format version of the Web document based upon the hierarchical data structure, wherein the user device format version of the Web document is suitable for interpretation and display by the user device that requested the Web document.

Other features and advantages of the present invention should be apparent from the following description of the preferred embodiment, which illustrates, by way of example, the principles of the invention.

### BRIEF DESCRIPTION OF THE DRAWINGS

These and other features of the invention will now be described with reference to the drawings summarized below. These drawings and the associated description are provided to illustrate a preferred embodiment of the invention, and not to limit the scope of the invention.

FIG. 1 is an architectural representation of a computer network system that implements the content transformation described herein.

FIG. 2 is a representation of Web content comprised of an exemplary Web page.

FIG. 3 is a schematic representation of a communication path that the content follows in the course of being transmitted from a content server to a user device.

FIG. 4 is a flow diagram that illustrates the general operations involved in the transfer and transformation of content from the content server to the user device.

FIG. 5 is a flow diagram that illustrates the process of transforming content from a native format into a user device format.

FIG. 6 is an illustration of a hierarchical tree structure that represents content.

FIG. 7 is an illustration of the results of collapsing and restructuring the hierarchical tree using the transformation rules.

FIG. 8 is an illustration of an exemplary summary page of content that is generated in accordance with the transformation.

FIG. 9 a schematic representation of an exemplary architecture of a content transformer that performs the content transformation described herein.

FIG. 10 is a block diagram of a computer device that is a node of the computer network of FIG. 1.

### DETAILED DESCRIPTION

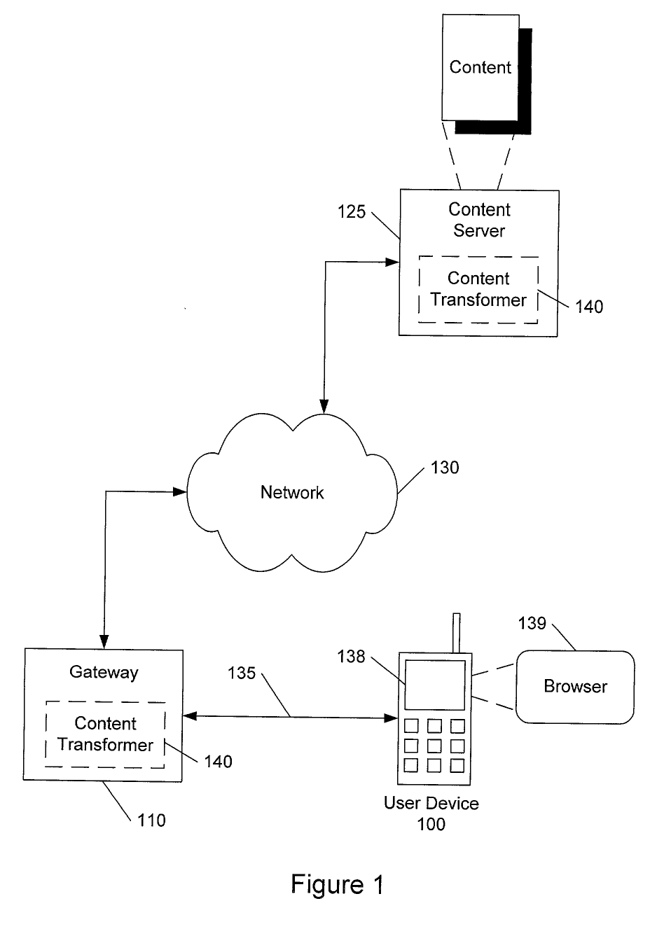

FIG. 1 shows the architecture of a computer network system comprised of a user device 100, a network gateway device 110, and a Web content server 125, which are nodes of a computer network. The network gateway device 110 and the content server 125 are communicatively linked via a computer network 130, such as the Internet. As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols. FIG. 1 shows only a single user device 100, a single server 125, and a single gateway device 110, although the computer network system could include a plurality of such devices.

As described in detail below, a content transformer 140 is configured to transform network content so that the content can be displayed on any type of user device 100. The content transformation is performed using a set of predefined rules that may provide both general and site-specific transformation. If the network 130 comprises the Internet, the user device 100 can advantageously browse any Web site on the Internet by way of the content transformer 140, which transforms Web content into a format suitable for the user device 100. The content transformer 140 preferably acts as a pass-through server between the content server 125 and the user device 100. Thus, the content transformer 140 can reside anywhere in the communication path between the content server 125 and the user device 100.

The user device 100 comprises any device that is configured to interact with the network 130. In one embodiment, the user device 100 comprises a mobile, hand-held device having an antenna that interacts with the network 130 through a wireless communication link 135 with the gateway device 110. The hand-held user device 100 is preferably of a size such that a human can hold and transport the user device 100 in his or her hand. Such devices include mobile phones and personal digital assistants and typically include a display screen having a size that is smaller than the display screens that are typically associated with personal computers. For example, a rectangular display screen 138 for the user device 100 may have a width and height that are both less than 5 inches.

A browser 139 preferably resides in the memory of the user device 100. The browser 139 is a software application that is used to request and display content from the network 130, such as World Wide Web pages. In the case of the user device 100 being a hand-held device, the browser 139 is preferably a microbrowser comprised of an Internet browser with a small file size that can accommodate the memory constraints of the user device 100 and the bandwidth constraints of the wireless communication link 135.

The gateway device 110 comprises a device, such as a computer, that functions as a communication entryway/exitway to/from the network 130 for the user device 100. The gateway device 110 provides the user device 100 with access to the network 130 such that any communication between the network 130 and the user device 100 travels through the gateway device 110. As mentioned, the user device 100 preferably communicates with the gateway device 110 via a wireless communication link 135. In this regard, the gateway device 110 preferably converts content received from the network 130 into a format suitable for transport over the wireless communication link 135.

The content server 125 comprises a computer system that stores content and serves the content over the network 130, such as using the standard protocols of the World Wide Web. The content server 125 is representative of any source of content available to the user device 100 via the network 130. The content server 125 is generally intended to encompass both the hardware and software server components that serve the content over the network 130. The content server 125 is not limited to comprising a single computer device, as the content server 125 could, for example, include multiple computer devices that are appropriately linked together.

As used herein, the term “content” refers to any type of electronic data that may be served by the content server 125 and transported over the network 130, including Web pages (also referred to herein as Web documents). The term “native format” is used herein to refer to the format in which the content is stored by the content server 125. The user device 100 may be unable to interpret and use content that is in a native format due, for example, to hardware capability restrictions of the user device 100 or software incompatibilities between the user device 100 and the content server 125. The term “user device format” is used to refer to content in a format that is suitable for interpretation and use by the user device 100.

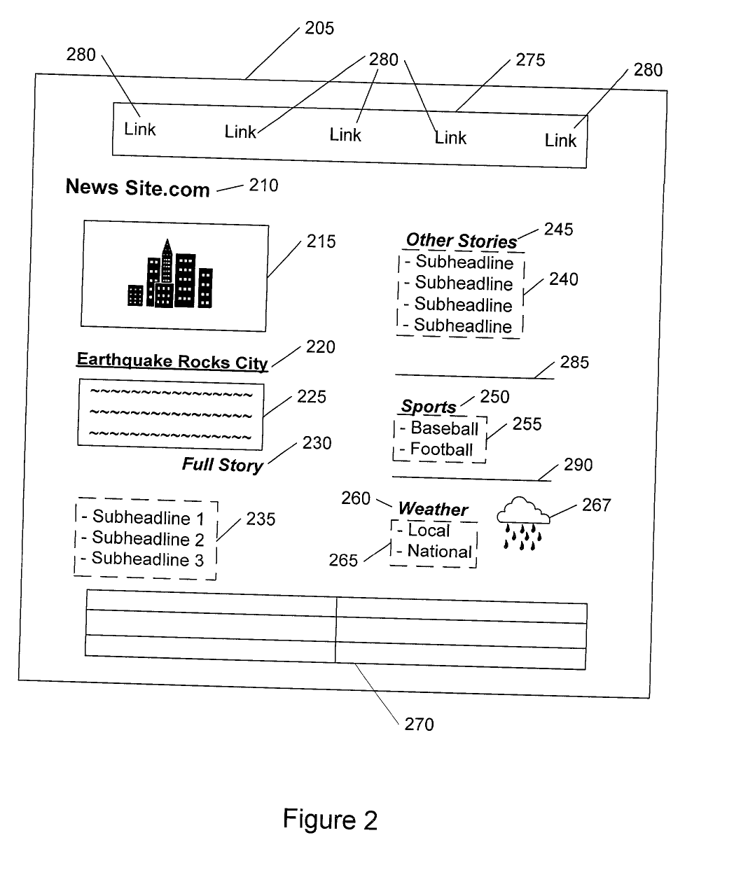

The content may be a Web page, which is comprised of a hyperlink document that is written in a descriptive markup language, such as, for example, the Hyper Text Markup Language (HTML), the Extensible Markup Language (XML), or the Extensible Hypertext Markup Language (XHTML), and that is available over the Internet. FIG. 2 shows an exemplary Web page 205 as it would normally be displayed on a window of a browser application, such as “Internet Explorer” from Microsoft Corporation or “Navigator” from Netscape Communications Corporation.

The Web page 205 is divided into several logical structures or elements, including headings, paragraphs, lists, separators, graphics, tables, table items, etc. The Web page 205 includes a main header 210 comprised of the term “NewsSite.com,” which identifies the Web page 205 as containing news-related information. The Web page 205 also includes a main news story that is identified with a graphic 215 and a main headline 220, which is accompanied by a paragraph 225. The paragraph 225 comprises a portion of an entire main story. A user may access the entire main story using an internal hyperlink 230 labeled “Full Story.” The internal hyperlink 230 is a logical link to a separate Web document that is served by the same server as the Web page 205 and that is subordinate to the Web page 205.

The Web page 205 also includes a set of subheadlines 235 comprised of one or more internal hyperlinks that point to additional news stories. The subheadlines 235 are situated on the lower left-hand portion of the Web page 205. A second set of subheadlines 240 (comprised of one or more internal hyperlinks) is located on the upper right-hand portion of the Web page 205. A header 245 identifies the general subject matter of the second set of subheadlines 240 as being “Other Stories.” In addition, another header 250 identifies a set of subject matter headlines 255 that are associated with sports stories. Yet another header 260 relates to a set of subheadlines 265 related to weather. A graphic 267 is associated with the weather-related subheadlines 265. Each of the subheadlines 235, 240, 255, and 265 may comprise internal hyperlinks that point to the full text of stories associated with the subheadlines. A pair of horizontal lines 285 and 290 serve as visual separators between the subheadlines 255 and 265.

The bottom region of the Web page 205 includes a table 270, which may include any of a variety of table items. A toolbar 275 resides at the top of the Web page 205. The toolbar 275 includes one or more external hyperlinks 280 that point to Web content that is not served by the same server as that associated with the Web page 205.

As mentioned, the Web page may be written in a descriptive markup language, such as HTML. The HTML code for the Web page 205 includes markup identifiers, or tags, that delimit the elements of the Web page. For example, the code could include a <H*> tag for delimiting a header element, a <L*> tag for delimiting a list item element, a <TD> tag for a table cell, and so forth.

The user device 100 may be unable to properly interpret and display the Web page 205 in its native format due to limitations in memory and display capabilities of the user device 100. For example, the microbrowser may not be configured to interpret certain of the HTML tags contained in the native format of the Web page 205 HTML code. The Web page 205 may also contain excessive text and graphics for proper fit on the display screen 138 of the user device 100. The Web page 205 may also contain too much data for storing in the memory of the user device 100. In such cases, the Web page would first have to be transformed into a user device format for proper use and display by the user device 100.

It should be appreciated that a transformation that consists of consecutively converting every single element in the Web page 205 into a series of corresponding elements in a transformed Web page would likely not suffice as a sufficient transformation. Such a transformation would likely result in a hodgepodge listing of major stories, headlines, subheadlines, table items, and graphics without regard for any hierarchy of the elements in the original Web page. Furthermore, such a transformed Web page would be confusing and difficult to navigate. Rather, the Web page is preferably transformed according to a set of rules to result in an easily navigable and concise overview of the Web page 205 with low bandwidth transmission requirements. The processes described herein will achieve such a result.

With reference again to FIG. 1, the content transformer 140 is configured to transform content into a user device format that is suitable for interpretation and display on the user device 100. The content transformer 140 preferably transforms content according to a set of predefined rules, which may be defined generally or on a page-by-page, site-by-site basis, and/or device-by-device basis, as described in more detail below. The content transformer 140 may comprise either the hardware and software components that perform the aforementioned content transformation, or both. In this regard, the content transformer 140 may comprise software that resides in the memory of the content server 125 and/or the gateway device 110. The content transformer 140 may also comprise a combination of software and hardware that is physically separate from the content server 125 and the gateway device 110.

Content Communication Path and General Transformation Process

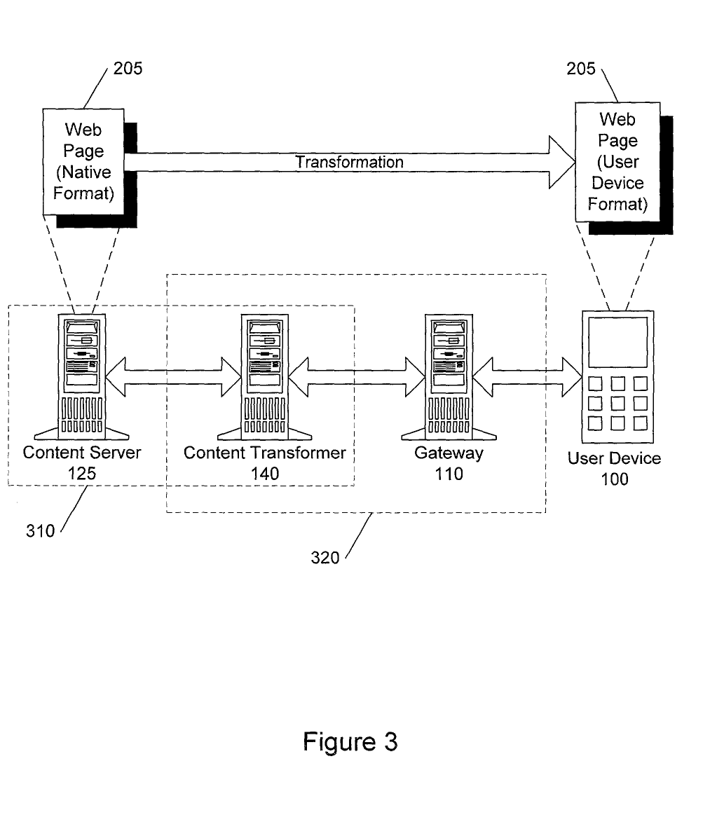

FIG. 3 schematically illustrates the communication path that content follows in the course of being transmitted from the content server 125 to the user device 100 according to one aspect of the invention. The content is described in the exemplary context of a Web page 205 that is stored and served by the content server 125. The communication path of the Web page 205 originates at the content server 125, where the Web page 205 is stored in a native format. The native format of the Web page 205 may comprise, for example, HTML code containing various HTML tags that define the Web page 205.

The communication path of the Web page 205 continues to the content transformer 140, where the Web page is transformed into a user device format. The transformation occurs wherever the content transformer 140 resides. The content transformer could reside at the content server 125 (as exhibited by the dashed box 310 in FIG. 3) or at the gateway device 110 (as exhibited by the dashed box 320 in FIG. 3). The content transformer 140 could also reside at a stand-alone site. A separate instance of the content transformer 140 may also be located at each location, in which case the downstream (closest to content server 125) instance of the content transformer 140 would allow the upstream (closest to user device 100) instance of the content transformer 140 to retrieve its rule set for correct processing. This ensures that the content rules are correctly utilized in the transformation process.

From the gateway device 110, the communication path of the Web page 205 continues to the user device 100. As a result of the transformations, the Web page 205 is in a user device format when received by the user device 100. The user device 100 can then display the Web page 205 on its display screen.

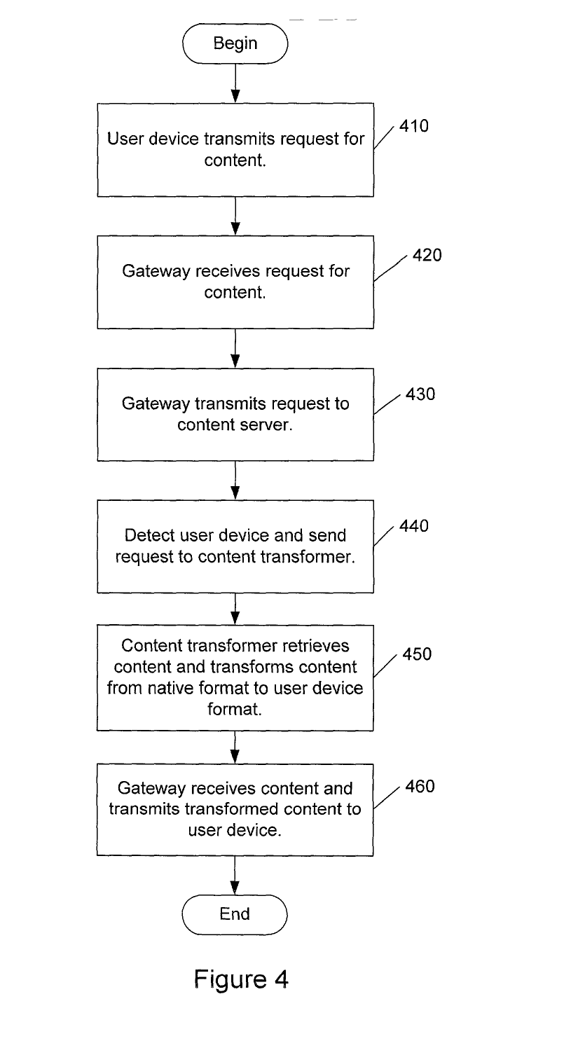

FIG. 4 is a flow chart that describes the general processes involved in the request, transfer, and transformation of content. In a first operation, represented by the flow diagram box numbered 410, the user device 100 transmits a request for content. The request includes a uniform resource locator (URL), which is a unique address that specifies the location of content on the network 130. In this example, the URL specifies the content server 125 as the location of the content. This could occur, for example, by the user selecting a hyperlink on the display screen of the user device 100 or by the user manually entering a URL using alpha-numeric keys on the user device 100.

The gateway device 110 receives the request for content, as represented by the flow diagram box numbered 420. In the next operation, the gateway device 110 transmits the content request to the content server 125 via the network 130, as represented by the flow diagram box numbered 430. Upon receipt of the request, the user device 110 is detected and the request is sent to the content transformer 140. This is represented by the flow diagram box numbered 440.

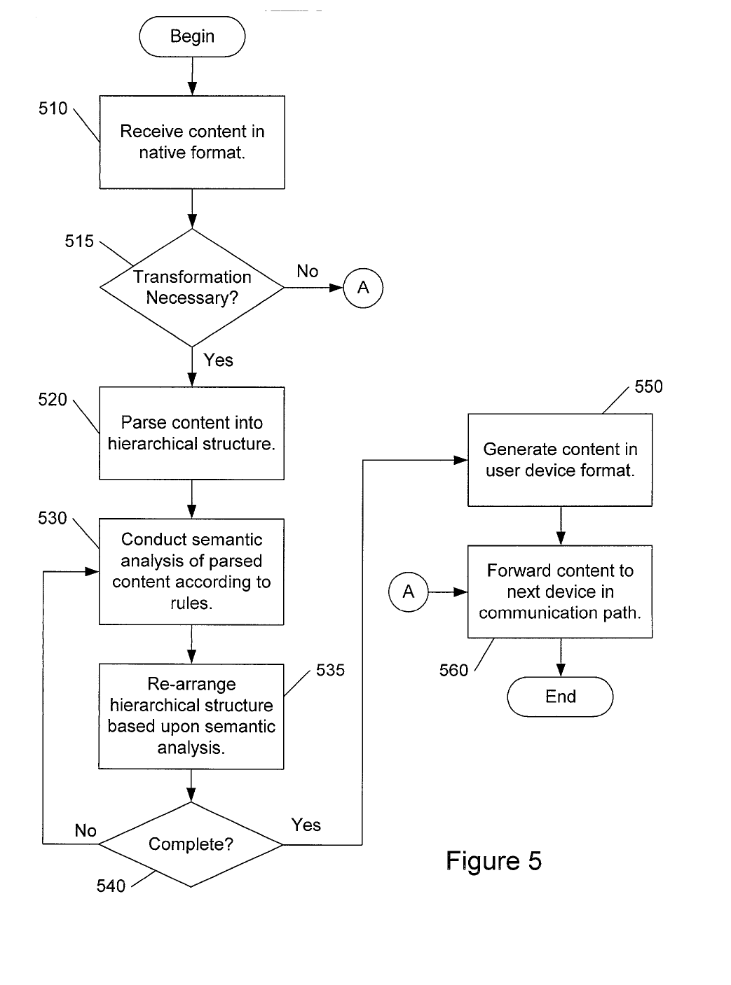

In the next operation, the content transformer 140 retrieves the requested content, which may be, for example, a Web page document written in HTML, and transforms the content from a native format into a user device format, as represented by the flow diagram box numbered 450. The content transformation process is described in more detail below with reference to FIG. 5. As mentioned, the content transformation occurs wherever the content transformer 140 resides, which could be at any of variety of locations along the communication path of the content.

The gateway device 110 then receives the content and transmits the transformed content to the user device 100 for display, as represented by the flow diagram box numbered 460.

The Content Transformation Process

FIG. 5 shows a flow chart that describes the operations involved in transforming the content from a native format into a user device format. In the first operation, represented by the flow diagram box numbered 510, the content transformer 140 receives the content.

The content transformer 140 then determines whether a transformation of the content is necessary, as represented by the flow diagram box numbered 515. The content need not be transformed if the native format is suitable for use by the user device 100. The content transformer 140 determines the MIME type of the requested content and determines if the user device 100 can or cannot accept this content without transformation. The content transformer 140 also receives information regarding the user device 100, including information regarding the memory capacity, display screen size, and data transmission bandwidth.

Furthermore, the content transformer 140 may already have a transformed version of the content stored in local cache memory, in which case transformation is not necessary and the content transformer 140 simply retrieves the transformed content from memory. If transformation is not necessary, then the content transformer 140 proceeds to forward the content to the next device in the content communication path, as represented by the flow diagram box numbered 560. The content transformer 140 may perform additional transformation on the content to put the content in a device specific format.

If the content transformer 140 determines that a transformation is necessary, then the process proceeds to the next operation, where the content transformer 140 parses the content. This operation is represented by the flow diagram box numbered 520. The content is preferably parsed into a format that may be handled by the remainder of the process, such as a hierarchical structure having one or more nodes that represent the elements that make up the native format of the content. For example, if the content comprises HTML code, the content transformer 140 reviews and parses the HTML tags and creates the hierarchical structure using an eXtensible Markup Language (“XML”) Document Object Model (“DOM”). The content transformer could parse the content using readily available software, such as openXML Parser. Also, any corresponding style sheets of the content, if present, are preferably also parsed to ensure that full formatting is retained in the final version of the content, which depends on the end user device's capabilities.

The hierarchical structure that results from the parsing provides a representation of all the elements of the native format content. For example, a hierarchical structure corresponding to the Web page 205 shown in FIG. 2 would contain nodes that correspond to all of the elements in the Web page 205, such as the main header 210, the main headline 220, the table 270, toolbar 275 and the various links, subheaders and subheadlines. The hierarchical structure would also include separator items such as the horizontal lines 285 and 290. The hierarchical structure would also include items that correspond to the table 270 and each of the individual items in the table.

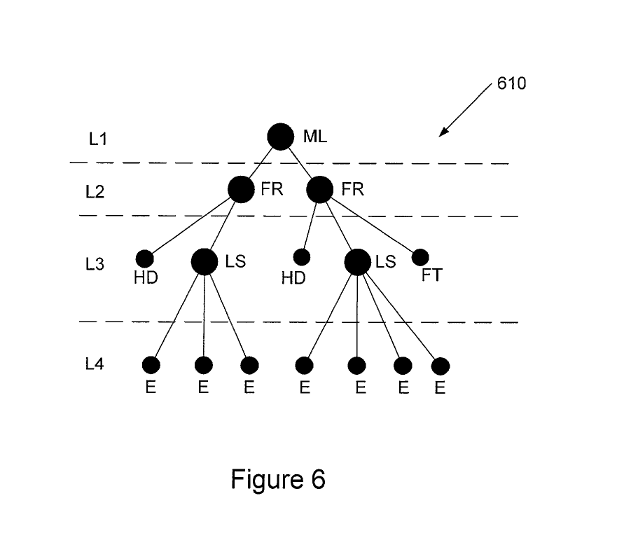

With reference to FIG. 6, the hierarchical structure could be represented by a tree diagram 610 that comprises one or more nodes (represented by circles) that each represent an element of the Web page, some of which span into one or more additional nodes. Nodes that share a common horizontal position on the tree diagram 610 are referred to as being on a common level. The tree diagram in FIG. 6 has four levels of nodes, L1, L2, L3, and L4, with L1 being the top or upper level and L4 being the bottom or lower level.

The hierarchy of nodes in the tree diagram preferably corresponds to the hierarchy of the elements of the content. Thus, the node(s) in the top level represent the uppermost hierarchical level of elements in the content. For example, in the Web page 205, the top level node may correspond to the main header 210, which as the title of the page, would preferably be on the highest hierarchical level for Web page 205. The main header 210 could have as children and grandchildren a node for the major headline 220 and a node for the paragraph 225 and the link 230. Other child nodes could comprise the various subheadlines 235, 240, 255, and 265, the table 270, and the items of the table 270. Even the horizontal lines 285, 290 could be associated with nodes on the hierarchical tree diagram. Thus, the original hierarchical structure includes nodes that represent all of the elements of the native format content, where some of the elements may be mere adornments for the Web page and some of the elements may be substantive.

During the parsing process, the content transformer preferably adorns the tree with identifiers that help to characterize the element associated with a particular node. The adornment is conducted using tags that are already embedded in the native format content. For example, the native format of a Web page written in HTML may include tags, such as <H*>, which identifies a header item or <L*>, which identifies a list item or <HR>, which identifies a horizontal line. Also, any graphics in the content are also characterized using the size and context of the graphics. In addition to the HTML tags, the content transformer also examines text, and structure of an element to characterize a node.

The original hierarchical structure that results from the parsing operation does not necessarily have a hierarchy that is optimal. This is because the original hierarchy may simply be based upon the location of the various tags and elements in the HTML code without regard for the relationships of the tags and elements to one another. For example, it may be undesirable to have the major headline on the same hierarchical level as the subheadlines, which are generally subordinate to the major headline. It may also be undesirable to have the items of the table on the same level as the major headline, as these items may represent subordinate type information. Thus, a simple parsing of the native format content without regard for the relationship and context of the content elements may not result in a proper hierarchy.

In any event, during the parsing operation, the content transformer 140 preferably passes any graphical elements of the content to a graphics processor. The content transformer also examines graphics elements to determine relationship to text, such as whether the graphics merely adorn the text or whether the graphics are substantive. If the graphics are adornment, the graphic may be eliminated (such as in the case of simple bullet type graphics) to reduce the processing overhead. In the case of substantive graphics, they are maintained in context with the remainder of the items from the content. The graphics processor separately transforms the graphics into a format that may be displayed by the user device 100. For example, in the Web page 205 shown in FIG. 2, the content transformer 140 would pass the graphic elements 215 and 267 to the graphics processor, placing a placeholder tag in the hierarchy pointing to the resulting graphic image.

With reference still to FIG. 5, in the next operation, represented by the flow diagram box numbered 530, the content transformer 140 commences a semantic analysis of the hierarchical structure, wherein the content transformer analyzes the meanings of text in the content and the arrangement of the elements. The content transformer 140 also analyzes the structural arrangement of the hierarchical structure, including a consideration of the location of elements in the structure and the location of elements with respect to other elements. The content transformer 140 preferably first stores the hierarchical structure as a separate data structure in memory. In conjunction with the semantic analysis, the content transformer 140 access a set of analysis rules (discussed below) that govern how the content transformer 140 conducts the semantic analysis. The content transformer 140 then re-arranges the hierarchical structure based upon the semantic analysis (using both generic rules and site specific/page specific rules), as represented by the flow diagram box numbered 535.

The re-arrangement may include re-organization of the nodes in the hierarchy, removal of one or more nodes from the hierarchy, merging of nodes, and the addition or revision of node identifiers. The semantic analysis and re-arrangement preferably results in a transformed hierarchical structure that properly reflects the hierarchy of the elements of the content. The operations represented by flow diagram boxes 530 and 535 are preferably recursively performed on the hierarchical structure.

In the course of the semantic analysis, the content transformer 140 preferably uses the analysis rules to classify each of the nodes as one of a predefined category. The categories may include at least the following:

(1) Element—an element is the most basic category and could correspond to an item that may be ultimately displayed in some format on the display screen of the user device 100. An element could comprise, for example, a list item, which is one of many items in a list. An element could also comprise a header or a footer. Additionally, an element could comprise a body of text, such as a paragraph from a story. With reference to FIG. 6, the hierarchical tree diagram 610 has several nodes that are elements E.

(2) List—a list is comprised of a collection of elements, such as a collection of list items. A list node may be exploded into one or more element nodes. On a hierarchical tree structure, a list node would be represented by a node that has one or more children nodes that represent the elements of the list. With reference to FIG. 6, the tree diagram 610 has two nodes that are labeled LS, signifying that they are lists. The list nodes LS each have one or more element nodes E as children.

(3) Fragment—a fragment is comprised of a list with a header and/or footer that is associated with the list. On a hierarchical tree structure, a fragment would be represented by a node that has a group of children nodes that represents the corresponding list along with one or more nodes that represent the headers/footers for the list. There are many other structures that can be treated as fragments, this is just one such example. The tree diagram 610 of FIG. 6 has two nodes that are labeled FR, signifying that they are fragment nodes, which each have at least one list node LS as a child along with a header node (HD) and/or a footer node (FT) as a child.

(4) Megalist—a megalist is comprised of a group of fragments. On a hierarchical tree structure, a megalist would be represented as a node that explodes into a group of children nodes, wherein each of the children nodes is a fragment. With reference to FIG. 6, the tree diagram 610 has a single megalist node ML, which is in the topmost level L1 and has a pair of fragment nodes FR as children.

It is appreciated that the categories are exemplary and that the elements could be categorized in other manners.

During the semantic analysis, the content transformer 140 recursively reviews the nodes in each of the levels of the hierarchical structure and applies the rules to each level in an attempt to classify the nodes. The rules are preferably grouped into various categories and the content transformer 140 selects which rules to use based upon the attribute identifiers that were adorned into the hierarchical structure during the parsing process. A general set of rules could be defined that is available in every embodiment of the content transformer 140. Additionally, there could also be provided specific rules that a user may define to suit his or her requirements, such as rules that apply to a specific Web site or to a specific user device. In this manner, the user could tailor the rules to suit particular needs.

Preferably, the content transformer begins the analysis with the lowermost levels in the hierarchical structure. After analyzing a given level, the content transformer preferably moves upwardly a level to analyze the nodes in the parent level. During an analysis of any given level, the content transformer preferably also analyzes the corresponding child level and again applies the rules to the child level. Thus, the recursive analysis may be generally described as a bottom-up, look-down analysis, where the analysis begins in the lowermost levels and moves upwardly to a parent level, and wherein a child level is analyzed on a look-down basis when the parent level is analyzed. At times both children and grandchildren nodes are reviewed in the analysis for rules matching.

The recursive classification of the nodes in the hierarchical structure typically results in a transformed hierarchical structure that is significantly different than the original hierarchical structure that resulted from parsing the content in the native format. Preferably, the transformed hierarchical structure is more compact and represents the user's original intent as to the hierarchy of the items in the content.

As mentioned, the content transformer consults various categories of rules. During at least a portion of the recursive analysis of the hierarchical structure, the content transformer 140 consults a category of removal rules and attempts to identify nodes that are eligible for removal from the hierarchical structure based upon the removal rules. The removal rules preferably help to identify nodes that unnecessarily increase the size of the hierarchical structure. Preferably, the nodes that correspond to decorator elements of the original content are candidates for removal from the hierarchical structure. Decorator elements are those components of the original content that aesthetically decorate but do not substantively contribute to the content. Separator elements are also candidates for removal. Separator elements can include, for example, horizontal lines and line breaks and bullet points, such as the horizontal lines 285 and 290 in the Web page 205 of FIG. 2. While the decorator and separator components could contribute aesthetically to the display of content, they may unnecessarily increase the size of the content for the user device format and so they are preferably removed from the user device format. However, they may also be retained for use on devices that can display these elements, thus maintaining as much of the original style as possible.

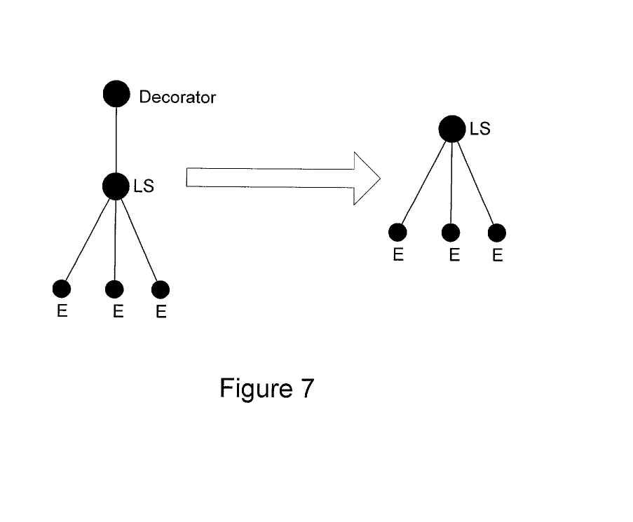

The content transformer 140 preferably also consults a set of merge rules, which govern whether one or more nodes should be and can be merged into a single node without interfering substantively with the hierarchical structure. An exemplary merge rule could specify that a child node should be consumed into a parent node if no information will be lost by the merge. For example, in the case where a parent has a single child and the parent is a mere decorator node, the parent can be consumed into the child because the parent decorator node is a candidate for removal anyway. This is exhibited in FIG. 7, where a tree diagram is first shown having a parent decorator node and a child list (LS) node. As a result of the application of the merge rules, the content transformer 140 merges the parent node into the child node, thereby reducing the size of the hierarchical structure by one level.

Another category of rules is configured to assist the content transformer 140 in identifying nodes that could be classified as header elements. In one example of such a rule, the content transformer could automatically classify as headers all nodes that were adorned with a header attribute during the parsing process. This would include nodes that correspond to components that are tagged with the <H*> HTML tag. Other candidates for header classification are those nodes that have characteristics that are typically associated with headers, such as nodes associated with bolded text or nodes associated with text of a particular length. It is appreciated that the types of rules that assist in identifying headers, or any other classification, could vary.

Another category of rules is configured to identify patterns in nodes of the hierarchical structure. The patterns rules relate to the location of elements in the hierarchical structure with respect to other elements in the hierarchical structure. For example, a pattern could comprise a group nodes in the same level and of a common parent that are associated with repeating patterns of text. The content transformer 140 preferably identifies nodes that follow such patterns for later use. Certain patterns provide an indication of the proper hierarchy of the tree structure. For example, repeating instances of bolded text can indicate that the text is part of a list of elements, which can indicate that the list items should be on a separate hierarchical level.

Yet another set of rules is configured to assist the content transformer 140 in identifying and classifying nodes that could be list nodes or elements that form a list. The rules preferably utilize any previously identified patterns in identifying nodes that are candidates for lists.

It should be appreciated that use of the rule categories recited herein increase the likelihood of the original hierarchical structure being transformed into a compact hierarchical structure that represents an accurate hierarchy of the original content. The rules are not limited to those described herein, but could be added to or revised.

As mentioned, the content transformer 140 preferably recursively applies the rules to the hierarchical structure on a level-by-level basis. The content transformer 140 begins at a lowermost node and either classifies the nodes in the level as a fixed category or else classifies the nodes a candidate for a particular category. Upon moving to the next level upward, the content transformer then again reviews the next lower level to ascertain whether any of the candidates nodes can be fixed into a particular category. The content transformer 140 conducts this level-by-level analysis repeatedly until all rules have been exhausted and the hierarchical structure has been sufficiently compacted. This results in a “Yes” outcome to the decision box numbered 540 in the flow diagram of FIG. 5.

Advantageously, application of the rules results in the recursive merging and rearranging of nodes and ultimately provides a streamlined and compact hierarchical structure that represents the content. At this point, the hierarchical structure is in a device independent or agnostic format. Moving upward through the levels of the transformed hierarchical structure, there is provided an increasingly wider overview of the content. Thus, the lowest levels represent the most granular elements of the content and the upper levels represent a more grand overview of the content. Accordingly, the uppermost level of the hierarchical structure represents a general summary or table of contents for the content.

In the operation represented by the flow diagram box numbered 550, the content transformer 140 uses the transformed hierarchical structure to generate content in a user device format, which is a format that is specific to the particular user device 100 that requested the content. The content transformer preferably examines the classified nodes of the hierarchical structure and also takes into account the particular capabilities of the user device 100. The content transformer 140 generates content that optimally fits on the user device 100. For example, the content transformer preferably divides the content into discrete data pieces or fragments, wherein the size of each data piece is tailored to fit within the bandwidth, screen display size, and memory capabilities of the user device 100. The data pieces are organized according to the transformed hierarchy. For example, in the context of a Web page, one such discrete piece of data could be a page of text that corresponds to a level from the transformed hierarchy, wherein the text represents a portion of the original Web page.

The content transformer 140 also determines how much of the original style and structure can be maintained on the user device 100. The content transformer preferably generates the content in a language that is suited for the user device 100. For example, the content transformer 140 can generate the content in Wireless Markup Language (WML) for a WML-enabled device.

The content transformer 140 preferably examines the hierarchical structure and determines how to best format the content for display on the user device 100. The content transformer 140 preferably divides blocks of text into smaller units that suit the data transmission requirements of the user device 100. The content transformer 140 also examines links in the content to determine whether the links refer to portions of the content being transformed or whether the links refer to a separate URL. A group of links, such as the group of subheadlines 235 may be collapsed into a single link that points to a separate page that presents the links serially. The content transformer 140 also examines list nodes to determine how to present the list on the user device 100. The lists may be presented as a single link that points to an intermediate level page that contains the actual listing. These intermediate levels of pages are determined based on the device capabilities, such as memory block sizes and display size.

Regarding tables, the content transformer 140 preferably analyzes the semantics of the items in the table to determine whether the table was used for aesthetic formatting or whether the table was used to display data in a particular order and relationship. Table structure that is utilized for true tabular based data is preferably maintained, and depending on the user device 100 capabilities, is displayed in a tabular structure, such as on PDAs.

In the next operation, the content transformer forwards the transformed content in the user device format to the next device in the communication path, as represented by the flow diagram box numbered 560.

Top Level Summary Page of Transformed Content

As mentioned, the nodes in the topmost level of the transformed hierarchical structure preferably represents a top level summarization of the content or, in other words, a table of contents for the content. For example, if the content is a Web page, the top level nodes would preferably represent a concise summary of the contents of the Web page. Preferably, the content transformer 140 generates a summary page for transmission to the user device 100, wherein the summary page includes a representation of the top level summary of the Web page. Preferably, summary page is the first page that is sent to the user device 100 for display on the user device display screen. The summary page preferably has links that lead to intermediate pages that are tailored for the memory, bandwidth, and display capabilities of the user device.

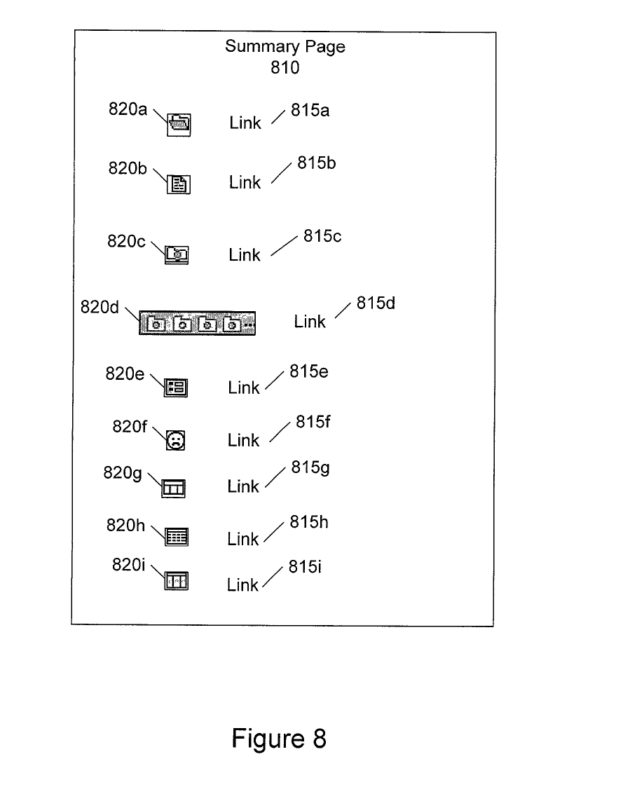

With reference to FIG. 8, there is shown an exemplary rendition of a summary page 810, which includes one or more links 815, which are differentiated using a letter suffix. The links 815 preferably include anchor text that describes the content of the link in order to assist the user in selecting a link. Additionally, each link 815 is preferably accompanied by a graphical identifier that aids the user in understanding the result of clicking on a particular link. In one embodiment, the graphical identifier comprises an icon 820, which provides a graphical representation of the result of clicking on a link. Preferably, the icon 820 provides some hint to the user as to the result of clicking on the corresponding link.

With reference to FIG. 8, the icons could include at least the following:

1. An icon 820a for identifying a link 815a that points to a page where content has been grouped as a set of links. The set of links could be internal links or external links or a combination thereof. In the illustrated embodiment, the icon 820a comprises an open folder graphic image;

2. An icon 820b that accompanies a link 815b, wherein selection of the link will provide the user with actual content. The actual content could comprise any original Web content, such as a news article with graphics, text, and a link, or any combination thereof. In the illustrated embodiment, the icon 820b comprises a graphic image that represents a page of text;

3. An icon 820c that identifies that selection of the corresponding link 815c will result in a request for access to a new URL. Such a request typically results in new content being accessed and processed by the content transformer 14. Consequently, the content transformer 140 will generate a new summary page that is based upon the new content;

4. An icon 820d that signifies that a list of external links will be displayed if the user selects the link 815d associated with the icon 820d, wherein the external links originally were represented as graphical icons on the original content. In the illustrated embodiment, the icon 820d comprises a graphical representation of a group of folders;

5. An icon 820e that signifies that a form or a portion thereof will be displayed when the user selects the link 815e associated with the icon 820e. The form will typically require that the user enter data therein using alphanumeric keys on the user device 100;

6. An icon 820f that represents that an image should have been displayed but that the server could not retrieve the image, such as because the server timed out in attempting to retrieve the image. The icon 820f could be accompanied by a link 815f that points to the image, thereby allowing the user to re-attempt retrieval of the image;

7. An icon 820g that signifies that tabular data is associated with the corresponding link 815g. In other words, the icon 820g signifies that the data associated with the link 815g was in tabular form in the original native format of the content. Following the link will display the tabular data in a format optimized for the user device 100;

8. An icon 820h that signifies that a row of data from a table will be displayed when the corresponding link 815h is selected, wherein the table was originally part of the native format of the content;

9. An icon 820i that signifies that a column of data from a table will be displayed when the corresponding link 815i is selected, wherein the table was originally part of the native format of the content.

The icons 820 shown in the summary page 810 of FIG. 8 are merely exemplary and any of the icons could be excluded as desired. The icons 820 could take on other forms as long as the icons 820 provide some hint to the user as to the result of clicking on the corresponding link. Moreover, it is appreciated that the summary page 810 could include additional icons not described herein, and could also include any combination of the aforementioned icons depending on the results of the top level summary of the content.

Advantageously, the summary page 810 provides a concise overview of the content for easy review by the user of the user device 100. The summary page 810 essentially contains a table of contents for the entire content in a single document that preferably consumes a minimum amount of data. This makes it more likely that the user device 100 will have the memory capacity to store and display the summary page. The concise summary page 810 also allows the user device 100 to receive small amounts of data that contain much usable information, thereby lowering the communication bandwidth requirements. The content transformer 140 can also generate pages that are subordinate to the top level summary page and that represent the various intermediate levels of the original content. In this manner, the user device 100 is provided with several discrete pages that represent the original Web page, wherein the discrete pages maintain the hierarchy of elements in the Web page and wherein the discrete pages are each tailored for the memory capacity and display capacity of the user device 100.

Exemplary Architecture of the Content Transformer

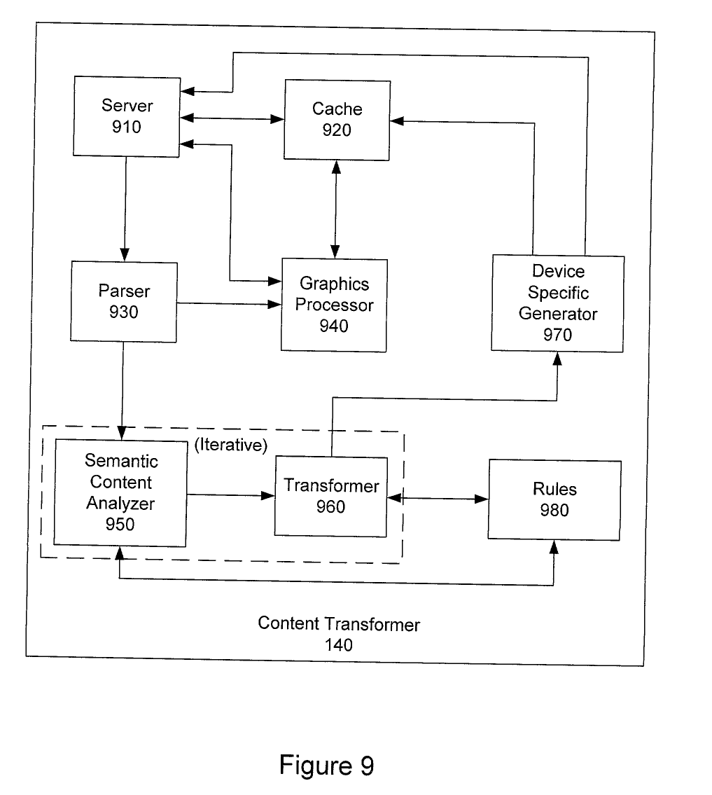

FIG. 9 is a block diagram that shows an exemplary architecture for the content transformer 140. A server 910 preferably controls the flow of data, including content to be transformed, into and out of the content transformer 140. The server 910 preferably determines the type of user device 100 that requested the content, such as by examining data that is readily available in an HTTP request for content (such as the user agent header). The server 910 communicates with a memory cache 920 that preferably stores transformed content. When the server 910 receives a request for content, the server 910 determines whether the content (or any portion thereof) is already stored in the cache in a user device format or in a device independent format. If so, the server 910 retrieves the content for transmission to the user device.

The server 910 preferably also conducts session management regarding content requests. The server 910 maintains a separate session for each user device 100. Each session preferably handles multiple requests for content and is kept alive until a time limit is expired, such as 20-60 minutes of inactivity from the user device. The session is established at the initial connection and preferably maintains history of all sites visited until it expires. The server 910 preferably stores session information comprised of information relating to the user device 100 and user, including a device ID, user name, user password, and the URL of content being requested and transformed. The server 910 can also include JavaScript information and form information.

The server 910 preferably includes support for VoiceXML processing, thereby allowing users of normal voice devices to interact with the network 130. A device specific Generator 970 generates VoiceXML compliant markup and grammar for forwarding to a VoiceXML gateway to the 130 network. The user device 110 then interacts in audio with this VoiceXML gateway. The server 910 is configured to receive VoiceXML compliant input from the user device and correctly handle all interactions.

The server 910 may comprise a combination of software and hardware components. The applicant has determined that an Apache Tomcat Java Server may be used as a platform for the server 910. The server 910 runs as a standard Java Server Page and can run with any of the industry standard servlet engines and web servers.

A parser 930 handles the parsing of content received from the server 910, which was described above with reference to the flow chart of FIG. 5. The parser 930 makes an initial pass through of the content and converts the native format of the content into a format that can be handled by the remainder of the transformation process. Furthermore, the parser 930 passes any reference to graphics links in the content to a graphics processor 940, including the filename and path for storage of the resulting transformed graphic. In response to such graphics links, the parser also adds an appropriate reference to the graphic in the hierarchical structure so that the server 910 can later retrieve the transformed graphic prior to transmission of the content. The parser 930 also passes on device characteristics to the graphics processor, such as screen size, memory constraints, bit depth, MIME type, etc., required to correctly render graphics for the user device 100.

The graphics processor 940 preferably transforms any graphic images in the content into a format that is suitable for display on the user device 100. In one embodiment, the graphics processor converts all graphics into a bitmap (BMP) file format, although graphics may be converted into any desired format. The graphics processor 940 renders thumbnail and/or full screen versions of the graphic image and stores the transformed image in the cache 920 for retrieval by the server 910.

The semantic content analyzer 950 conducts the semantic content analysis that was described in the flow chart of FIG. 5. The semantic content analyzer 950 receives the content from the parser 930 and adorns the hierarchical structure of the content with attributes based upon the set of rules. After the analysis is complete, the semantic content analyzer 950 passes the content to the transformer 960. The transformer 960 then reorganizes, summarizes, and removes information, where appropriate, from the hierarchical structure based upon the attributes that were provided by the semantic content analyzer 950. This is an iterative cycle until no further rules apply. When the transformer 960 completes its process, it passes the newly-structured hierarchical structure to a device specific generator 970.

The device specific generator 970 takes the hierarchical structure and generates content that is configured to be displayed on the user device 100. The device specific generator 970 preferably embeds in the content references to the graphic images that were previously parsed out of the content. The device specific generator 970 then passes the content to the server 910 for transmission to the user device 100.

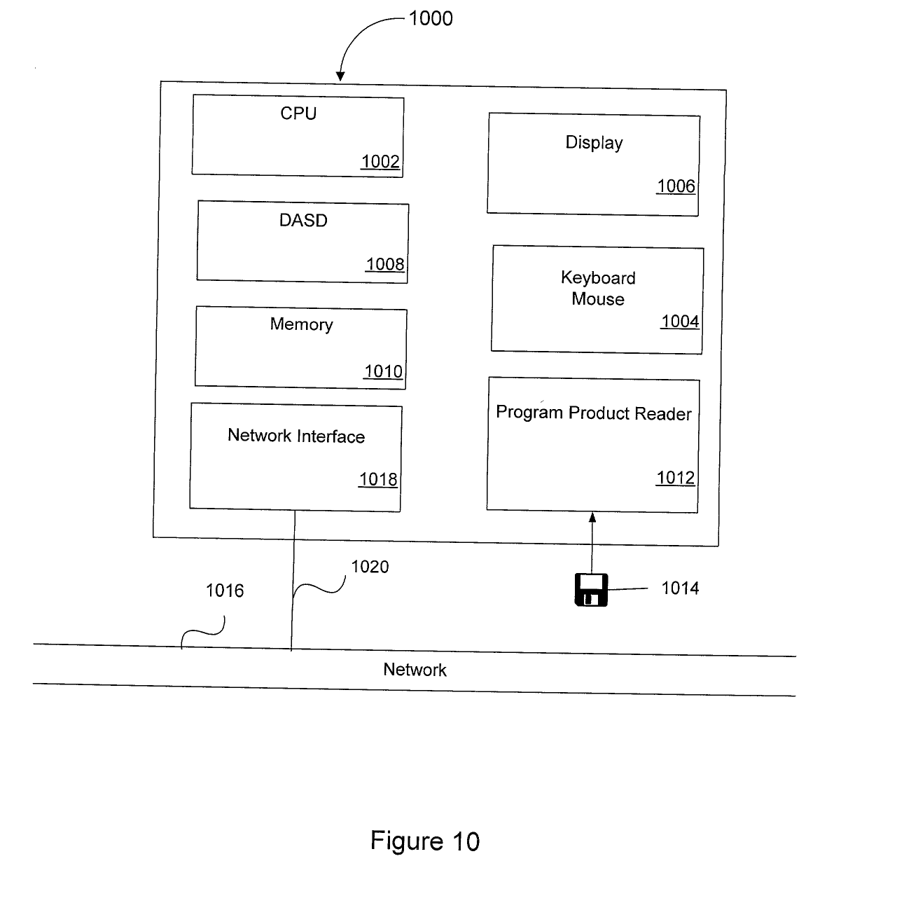

FIG. 10 is a block diagram of an exemplary computer 1000 such as might comprise any of the nodes of the computer network 130, such as the gateway device 110 or the content server 125. The computer 1000 operates under control of a central processor unit (CPU) 1002, such as a “Pentium” microprocessor and associated integrated circuit chips, available from Intel Corporation of Santa Clara, Calif., USA. A computer user can input commands and data from a keyboard and computer mouse 1004, and can view inputs and computer output at a display 1006. The display is typically a video monitor or flat panel display. The computer 1000 also includes a direct access storage device (DASD) 1008, such as a hard disk drive. The memory 1010 typically comprises volatile semiconductor random access memory (RAM). The computer preferably includes a program product reader 1012 that accepts a program product storage device 1014, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

The computer 1000 can communicate over a computer network 1016 (such as the Internet or an intranet) through a network interface 1018 that enables communication over a connection 1020 between the network 1016 and the computer. The network interface 1018 typically comprises, for example, a Network Interface Card (NIC) that permits communications over a variety of networks.

The CPU 1002 operates under control of programming steps that are temporarily stored in the memory 1010 of the computer 1000. When the programming steps are executed, the computer performs its functions. Thus, the programming steps implement the functionality of the content transformer 140. The programming steps can be received from the DASD 1008, through the program product storage device 1014, or through the network connection 1020. The program product storage drive 1012 can receive a program product 1014, read programming steps recorded thereon, and transfer the programming steps into the memory 1010 for execution by the CPU 1002. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1010 over the network 1016. In the network method, the computer receives data including program steps into the memory 1010 through the network interface 1018 after network communication has been established over the network connection 1020 by well-known methods that will be understood by those skilled in the art without further explanation. The program steps are then executed by the CPU. Any of the nodes of the computer network can have an alternative construction, so long as it can support the functionality described herein. For example, the user device 100 may comprise a mobile device that has an antenna and at least some of the components of the computer 1000.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

We claim:

1. A method of transforming a Web document from a first format into a second format, comprising:
retrieving a copy of the Web document wherein the Web document comprises at least one element that is delimited and identified by at least one tag within the Web document;
parsing the Web document to create a first data structure comprised of a first hierarchical organization of elements from the Web document;
conducting a semantic analysis of the elements in the data structure; and
re-arranging the elements in the first data structure based upon the semantic analysis to form a second data structure comprised of a new hierarchical organization of elements from the Web document, wherein the new hierarchical organization differs from the first hierarchical organization.

2. A method as defined in claim 1, additionally comprising:
receiving information regarding a user device that requested the Web document; and
creating a device-specific version of the Web document using the second data structure, the device-specific version of the Web document comprised of at least some of the elements in the second data structure, wherein the device-specific version of the Web document is tailored for display on the user device that requested the Web document and is organized according to the new hierarchical organization.

3. A method as defined in claim 2, wherein the information regarding the user device includes memory capacity, display screen size, and data transmission bandwidth.

4. A method as defined in claim 2, wherein the device-specific version of the Web document is divided into discrete data fragments and wherein each data fragment is tailored to fit within data bandwidth capabilities of the user device, memory capabilities of the user device, and display capabilities of the user device.

5. A method as defined in claim 4, wherein the device-specific version of the Web document includes a top level data fragment that represents a top level summary of the Web document.

6. A method as defined in claim 2 wherein the device-specific version of the Web document is written in a markup language that can be interpreted by the user device.

7. A method as defined in claim 1, wherein the Web document comprises descriptive markup language code, and wherein parsing the Web document comprises identifying elements in the Web document based upon the location of the tags in the code and creating a node in the hierarchical structure for each element.

8. A method as defined in claim 7, wherein the descriptive markup language comprises the HyperText Markup Language (HTML), the Extensible Markup Language (XML), or the Extensible Hypertext Markup Language (XHTML).

9. A method as defined in claim 1, wherein re-arranging the first data structure includes deleting at least some of the elements from the hierarchical structure.

10. A method as defined in claim 1, wherein re-arranging the first data structure includes adding new elements to form the second data structure.

11. A method as defined in claim 1, wherein re-arranging the first data structure includes merging a first element and a second element from the hierarchical structure into a single element.

12. A method as defined in claim 1, wherein conducting a semantic analysis of the elements in the data structure includes analyzing each of the elements in the hierarchical data structure, beginning with elements in a lowermost level in the hierarchical data structure and then analyzing the elements in a level above the lowermost level.

13. A method as defined in claim 1, additionally comprising analyzing the structural arrangement of the elements in the first data structure including examining the location of elements in the data structure with respect to other elements in the data structure.

14. A method as defined in claim 1, wherein semantically analyzing the elements in the first data structure includes determining whether any of the elements are headers.

15. A method as defined in claim 1, wherein semantically analyzing the elements in the first data structure includes determining whether any of the elements are list items.

16. A method as defined in claim 1, wherein semantically analyzing the elements in the data structure comprises categorizing each of the data elements into a predefined category based upon a set of rules and appending an identifier to each data element to identify the category of the data element.

17. A method as defined in claim 14, wherein the first data structure is re-arranged according to the category of the data element.

18. A method of converting a Web page from a first format into a second format, comprising:
identifying page elements in the Web page;
creating a native hierarchical arrangement having nodes that each correspond to a Web page element from the Web page;
performing a structural and semantic analysis on the native hierarchical arrangement according to a set of rules, wherein the semantic analysis comprises examining the relative location and meaning of each element in the native hierarchical arrangement and identifying nodes for deletion from the hierarchical structure; and
creating a transformed hierarchical arrangement based upon the structural and semantic analysis, wherein the transformed hierarchical arrangement takes into account the relative location and meaning of the elements in the native hierarchical arrangement.

19. A method as defined in claim 18, additionally comprising:
creating at least one transformed Web page comprising Web page elements from the transformed hierarchical arrangement, the Web page elements being arranged according to a hierarchy that corresponds to the transformed hierarchical arrangement.

20. A method as defined in claim 19, wherein the at least one transformed Web pages each have a data size that is tailored to fit within a memory capacity, display screen size, and data transmission bandwidth of a user device that requests the Web page.

21. A method as defined in claim 20, wherein at least one of the transformed Web pages includes a table of contents for the transformed Web pages.

22. A method as defined in claim 18, wherein the native Web page format comprises a HyperText Markup Language, Extensible Markup Language (XML), or Extensible Hypertext Markup Language (XHTML) format.

23. A method as defined in claim 18, wherein the predefined Web page elements comprise elements that are identified by HyperText Markup Language tags.

24. A method as defined in claim 18, wherein at least some of the predefined Web page elements comprise links that point to additional Web pages.

25. A method as defined in claim 18, wherein the method further comprises receiving a request for a Web page and providing the transformed Web page in response to the request.

26. A method as defined in claim 18, wherein the native hierarchical arrangement includes plural levels, and wherein semantic analysis is conducted level-by-level for each level in the native hierarchical arrangement.

27. A method as defined in claim 18, wherein the Web page elements are identified using tags in the Web page.

28. A method as defined in claim 18, wherein each node in the hierarchical arrangement is associated with an identifier that corresponds to the tag for the element associated with the node.

29. A method of transforming a Web document, comprising:
retrieving a native format version of the Web document, the Web document including at least one element that is delimited by at least one tag in the Web document, wherein the native format version of the Web document is not suitable for interpretation and display by a user device that requested the Web document;
performing an analysis of the elements of the Web document, the analysis taking into account semantics of the elements and a structural arrangement of the elements;
rearranging the elements as a result of the analysis to generate a hierarchical data structure that represents the Web document;
generating a user device format version of the Web document based upon the hierarchical data structure, wherein the user device format version of the Web document is suitable for interpretation and display by the user device that requested the Web document.

30. A method as defined in claim 29, additionally comprising:
receiving information regarding a user device that requested the Web document, the information including memory capacity, display screen size, and data transmission bandwidth, wherein the user device format version of the Web document is divided into discrete data fragments and wherein each data fragment is tailored to fit within the memory capacity, data transmission bandwidth, and display screen size of the user device.

31. A method as defined in claim 30, wherein the user device format version of the Web document includes a top level data fragment that represents a top level summary of the Web document.

32. A system that transforms a Web document from a first format into a second format, the system comprising one or more processors that execute program instructions and receive a data set, wherein the program instructions are executed to cause the processor to:
retrieve a copy of the Web document wherein the Web document comprises at least one element that is delimited and identified by tags within the Web document;
parse the Web document to create a first data structure comprised of a first hierarchical organization of elements from the Web document;
conducts a semantic analysis of the elements in the data structure; and
re-arrange the elements in the first data structure based upon the semantic analysis to form a second data structure comprised of a new hierarchical organization of elements from the Web document, wherein the new hierarchical organization differs from the first hierarchical organization.

33. A system as defined in claim 31, wherein the program instructions are further executed to cause the processor to:
receive information regarding a user device that requested the Web document, the information including memory capacity, display screen size, and data transmission bandwidth; and
create a device-specific version of the Web document using the second data structure, the device-specific version of the Web document comprised of at least some of the elements in the second data structure, wherein the device-specific version of the Web document is tailored for display on the user device that requested the Web document and is organized according to the new hierarchical organization.

34. A system as defined in claim 33, wherein the device-specific version of the Web document is divided into discrete data fragments and wherein each data fragment is tailored to fit within data bandwidth capabilities of the user device, memory capabilities of the user device, and display capabilities of the user device.

35. A program product for use in a computer system that executes program steps recorded in a computer-readable media to perform a method for transforming a Web document from a first format into a second format, the program product comprising:
a recordable media;
a program of computer-readable instructions executable by the computer system to perform operations comprising:
retrieving a copy of the Web document wherein the Web document comprises at least one element that is delimited and identified by tags within the Web document;
parsing the Web document to create a first data structure comprised of a first hierarchical organization of elements from the Web document;
conducting a semantic analysis of the elements in the data structure; and
re-arranging the elements in the first data structure based upon the semantic analysis to form a second data structure comprised of a new hierarchical organization of elements from the Web document, wherein the new hierarchical organization differs from the first hierarchical organization.

36. A system that converts a Web page from a first format into a second format, the system comprising one or more processors that execute program instructions and receive a data set, wherein the program instructions are executed to cause the processor to:
identify page elements in the Web page;
create a native hierarchical arrangement having nodes that each correspond to a Web page element from the Web page;
perform a structural and semantic analysis on the native hierarchical arrangement according to a set of rules, wherein the semantic analysis comprises examining the relative location and meaning of each element in the native hierarchical arrangement and identifying nodes for deletion from the hierarchical structure; and
create a transformed hierarchical arrangement based upon the structural and semantic analysis, wherein the transformed hierarchical arrangement takes into account the relative location and meaning of the elements in the native hierarchical arrangement.

37. A program product for use in a computer system that executes program steps recorded in a computer-readable media to perform a method for converting a Web page from a first format into a second format, the program product comprising:
a recordable media;
a program of computer-readable instructions executable by the computer system to perform operations comprising:
identifying page elements in the Web page;
creating a native hierarchical arrangement having nodes that each correspond to a Web page element from the Web page;
performing a structural and semantic analysis on the native hierarchical arrangement according to a set of rules, wherein the semantic analysis comprises examining the relative location and meaning of each element in the native hierarchical arrangement and identifying nodes for deletion from the hierarchical structure; and
creating a transformed hierarchical arrangement based upon the structural and semantic analysis, wherein the transformed hierarchical arrangement takes into account the relative location and meaning of the elements in the native hierarchical arrangement.

38. A system that transforms a Web document, the system comprising one or more processors that execute program instructions and receive a data set, wherein the program instructions are executed to cause the processor to:
retrieve a native format version of the Web document, the Web document including at least one element that is delimited by at least one tag in the Web document, wherein the native format version of the Web document is not suitable for interpretation and display by a user device that requested the Web document;
perform an analysis of the elements of the Web document, the analysis taking into account semantics of the elements and a structural arrangement of the elements;
rearrange the elements as a result of the analysis to generate a hierarchical data structure that represents the Web document;
generate a user device format version of the Web document based upon the hierarchical data structure, wherein the user device format version of the Web document is suitable for interpretation and display by the user device that requested the Web document.

39. A program product for use in a computer system that executes program steps recorded in a computer-readable media to perform a method for transforming a Web document, the program product comprising:
a recordable media;
a program of computer-readable instructions executable by the computer system to perform operations comprising:
retrieving a native format version of the Web document, the Web document including at least one element that is delimited by at least one tag in the Web document, wherein the native format version of the Web document is not suitable for interpretation and display by a user device that requested the Web document;
performing an analysis of the elements of the Web document, the analysis taking into account semantics of the elements and a structural arrangement of the elements;
rearranging the elements as a result of the analysis to generate a hierarchical data structure that represents the Web document;
generating a user device format version of the Web document based upon the hierarchical data structure, wherein the user device format version of the Web document is suitable for interpretation and display by the user device that requested the Web document.

40. A system that transforms a Web document from a first format into a second format, comprising:
a parser that parses a Web document that comprises at least one element that is delimited and identified by at least one tag within the Web document to create a first data structure comprised of a first hierarchical organization of elements from the Web document;
a semantic content analyzer that conducts a semantic analysis of the elements in the data structure; and
a transformer that re-arranges the elements in the first data structure based upon the semantic analysis to form a second data structure comprised of a new hierarchical organization of elements from the Web document, wherein the new hierarchical organization differs from the first hierarchical organization.
